(19) United States
(12) Patent Application Publication
(10) Pub. No.: US 2015/0043309 A1
(43) Pub. Date: Feb. 12, 2015

(54) ULTRASONIC LOCATIONING USING FLIGHT TIME CALCULATED FROM COUNTER OFFSETS

(71) Applicant: SYMBOL TECHNOLOGIES, INC., SCHAUMBURG, IL (US)

(72) Inventor: Russell E. Calvarese, Stony Brook, NY (US)

(73) Assignee: SYMBOL TECHNOLOGIES, INC., SCHAUMBURG, IL (US)

(21) Appl. No.: 13/963,053

(22) Filed: Aug. 9, 2013

(51) Int. Cl. G01S 5/26

(52) U.S. Cl. CPC G01S 5/26
USPC 367/117

(57) ABSTRACT

Using counter offsets to allow flight time calculation in an ultrasonic locationing system includes ultrasonic transmitters for emitting ultrasonic bursts, each transmitter having a counter and a synchronization server. A backend controller schedules periodic bursts from each transmitter. A mobile device also has a counter and can receive the ultrasonic bursts, wherein the mobile device can determine a relative counter offset between itself and a transmitter. The mobile device can calculate a corrected reception time of ultrasonic bursts from the transmitters based on the counter value when the burst is detected and the relative counter offset between the mobile device and the transmitter, and report the corrected time to the backend controller for locationing of the mobile device.

### BACKGROUND

Ultrasonic transmitters can be used to determine the location of devices that can receive ultrasonic signals, such as a mobile device present within a retail, factory, or warehouse environment, for example. The ultrasonic transmitter includes an emitter (e.g. transponder or speaker) that can transmit ultrasonic energy in a short burst which can be received by a transducer (e.g. microphone) in the mobile device. For example, today's unmodified smart phones have audio hardware and circuitry that is capable of receiving ultrasonic signals in the 20-22 kHz frequency range.

Further, the use of several ultrasonic transmitters within the environment can also be used to provide a specific location of a particular device using differential flight time techniques known in the art that incorporate triangulation, trilateration, and the like. Existing systems have shortcomings that don't lend themselves to working with unmodified smartphones.

For one type of existing system, the receiver measures times between detection of RF transmission and detection of the ultrasonic pulse. This detection is done at the hardware level. Existing smart phones do not have the ability to detect when an RF reception occurs at the hardware level. Detection at the software level does not provide enough accuracy. Enabling such ability would require modifications to hardware/software of radio adapters inside the smartphone that would require cooperation with many smart phone manufacturers, something that is not practical or possible in many cases.

A second type of existing system, Time Difference of Arrival (TDOA) is used to locate unmodified smart phones. TDOA systems do not need to determine when the ultrasonic pulse is transmitted allowing unmodified smartphones to function. However, TDOA systems require one more transmitter than a flight time based system and system accuracy falls off quickly with distance.

A third type of existing system uses RSSI. While RSSI lends itself well to functioning with unmodified smart phones, the accuracy is poor.

In addition to the shortcomings note above for ultrasonic locationing systems, any locationing system that utilizes existing synchronization approaches have the following shortcomings. Clock synchronization where clocks are adjusted are subject to being adjusted by other mechanisms unrelated to the locationing system could affect ultrasonic locationing performance. Existing IEEE1588 solutions don't have the required accuracy to support ultrasonic flight time based locationing.

Accordingly, there is a need for an improved technique to provide flight time determination for an ultrasonic locationing system without requiring modifications to existing receiving hardware.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an ultrasonic locationing system, in accordance with some embodiments of the present invention.

FIG. 2 is a representation of a flow diagram, in accordance with some embodiments of the present invention.

FIG. 3 is a graphical representation of a timing diagram, in accordance with some embodiments of the present invention.

FIG. 4 is a diagram illustrating a method, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to some embodiments of the present invention, an improved technique is described to provide flight timing accuracy for an ultrasonic locationing system without requiring clock synchronization of devices or hardware modifications to mobile devices. In particular, the present invention calculates relative timing offsets between mobile devices and ultrasonic transmitters, and uses these relative timing offsets in flight time calculations that can be used for more accurate locationing of mobile devices, as will be described below.

An ultrasonic locationing system should have the highest possible accuracy. A problem with ultrasonic locationing is that accuracy decreases with distance and time. Therefore, it is desired to have an increased number of emitters to be closer to devices to be located, and to have a high position refresh rate. Therefore, the present invention schedules emitter bursts in cooperation to avoid collisions and to give ample time to account for ultrasonic flight times so that a mobile device can hear and respond to nearby emitters before subsequent emissions.

The device to be located can include a wide variety of business and consumer electronic platforms such as cellular radio telephones, mobile stations, mobile units, mobile nodes, user equipment, subscriber equipment, subscriber stations, mobile computers, access terminals, remote terminals, terminal equipment, cordless handsets, gaming devices, personal computers, and personal digital assistants, and the like, all referred to herein as a device. Each device comprises a processor that can be further coupled to a keypad, a speaker, a microphone, a display, signal processors, and other features, as are known in the art and therefore not shown.

Various entities are adapted to support the inventive concepts of the embodiments of the present invention. Those skilled in the art will recognize that the drawings herein do not depict all of the equipment necessary for system to operate but only those system components and logical entities particularly relevant to the description of embodiments herein. For example, routers, controllers, switches, access points/ports, and wireless clients can all includes separate communication interfaces, transceivers, memories, and the like, all under control of a processor. In general, components such as processors, transceivers, memories, and interfaces are well-known. For example, processing units are known to comprise basic components such as, but not limited to, microprocessors, microcontrollers, memory cache, application-specific integrated circuits, and/or logic circuitry. Such components are typically adapted to implement algorithms and/or protocols that have been expressed using high-level design languages or descriptions, expressed using computer instructions, expressed using messaging logic flow diagrams.

Thus, given an algorithm, a logic flow, a messaging/signaling flow, and/or a protocol specification, those skilled in the art are aware of the many design and development techniques available to implement one or more processors that perform the given logic. Therefore, the entities shown represent a system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the memory and control aspects of the present invention may be implemented in any of the devices listed above or distributed across such components.

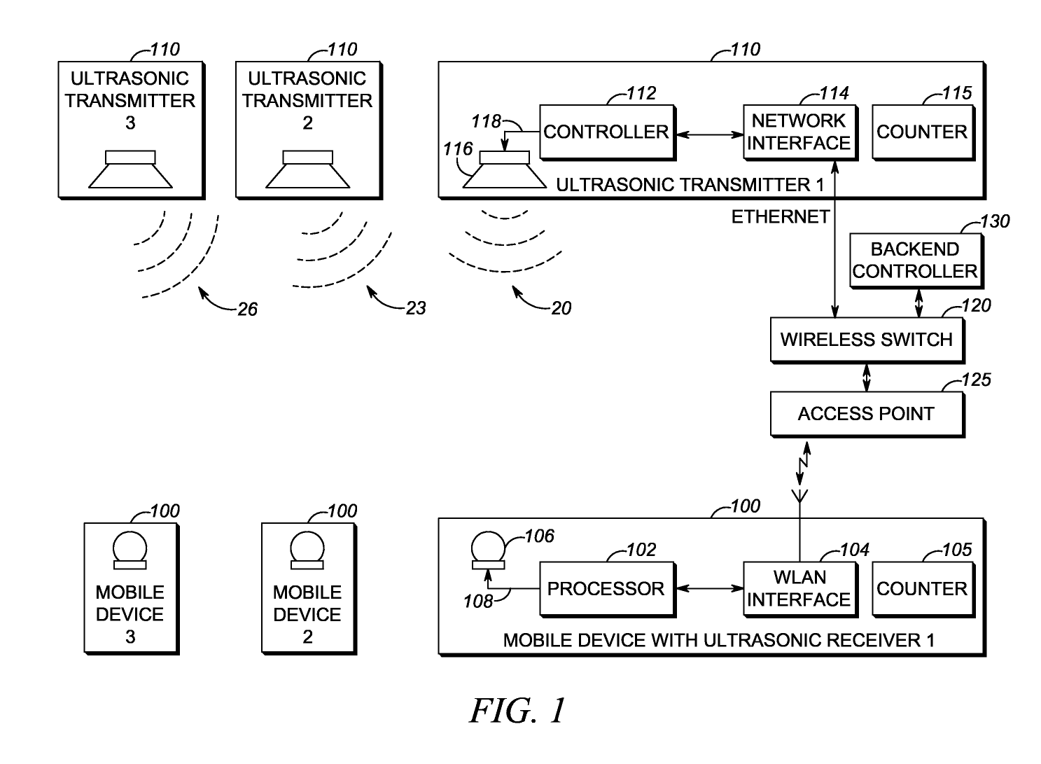

FIG. 1 is a block diagram of an ultrasonic locationing system, in accordance with the present invention. An ultrasonic transponder such as a piezoelectric speaker or emitter 116 can be implemented within an ultrasonic transmitter 110. The emitter can send a short burst of ultrasonic sound (e.g. an ultrasonic sound pressure wave 20) for a mobile device 100 to hear within the environment. The mobile device 100 can include a transducer such as an existing microphone 106 to receive the burst 20. The mobile device also includes existing audio circuitry to convert the burst into an electrical signal 108. The mobile device also includes an existing processor 102 to convert and process the signal. The processor 102 can also be coupled to a wireless local area network interface 104 for wireless communication with other devices in a communication network.

The communication network can include local and wide-area wireless networks, wired networks, or other IEEE 802.11 or Wi-Fi™ wireless communication systems, including virtual and extended virtual networks. It is envisioned that the communication network includes a backend controller/scheduler 130 that performs network control and provides the locationing engine. The backend controller can be connected to a network switch 120 which can be wired (e.g. an Ethernet interface connection) or wirelessly (e.g. IEEE's 802.11 or Wi-Fi™) connected to a plurality of ultrasonic transmitters 110, and at least one wireless access point 125 used for communicating with the mobile devices 100.

It should be recognized that the present invention can also be applied to other wireless communication systems. For example, the description that follows can apply to one or more communication networks that are IEEE 802.xx-based, employing wireless technologies such as IEEE's 802.11, 802.16, or 802.20, modified to implement embodiments of the present invention. The protocols and messaging needed to establish such networks are known in the art and will not be presented here for the sake of brevity.

In order to provide more accurate locationing ability, using a flight time technique for example, the present invention utilizes a plurality of ultrasonic transmitters 110 within the environment each carrying an emitter 116. For unobtrusiveness and clear signaling, the transmitters can be affixed to a ceiling of the environment, where the position of each transmitter is fixed and known by the backend controller 130. The present invention will use flight time information of multiple bursts from different transmitters 110 to locate the mobile device. As the location and position of these transmitters 110 is known and fixed, the different signals received by the device microphone from each transmitter can be used to locate and track the position of the mobile device using flight time information using a suitable locationing technique such as triangulation, trilateration, multilateration, etc.

In practice, the mobile device 100 will not know which particular transmitter is the one emitting the ultrasonic burst. Therefore, some control over each emitter must be exercised in order to know which emitter is transmitting, and which emitter is located at which position. In one embodiment, the backend controller 130 of the locationing system can communicate over the communication network in order to direct the different emitters 116 to emit an ultrasonic signal burst at different times such that a mobile device will not receive overlapping signals from different emitters. This can be accomplished using IEEE 802.11 polling to initiate the ultrasonic burst. For example, the backend scheduler can communicate with ultrasonic transmitter 1 to cause it to transmit an ultrasonic burst at a time reserved for that transmitter. Upon receiving the burst, the device 100 can communicate with the backend controller over the communication network that it has received the burst (along with timing information), and the backend controller will then know that the burst came from ultrasonic transmitter 1 due to the general time it was received by the mobile device.

It is important in the present invention that the network devices know their relative timing during communications. This is accomplished by incorporating a synchronization server function into the ultrasonic transmitters. The present invention does not set clocks such that they are set the same in each device, as is done in absolute clock synchronization. Instead, high resolution, high priority counters 105, 115 are used in each device such that relative timing offsets can be determined Such internal counters are already present in smart phones for communication purposes, for example. Accordingly, the present invention performs an initial counter offset determination before communications commence between two devices. This counter offset determination can be repeated during operation of the device in the system.

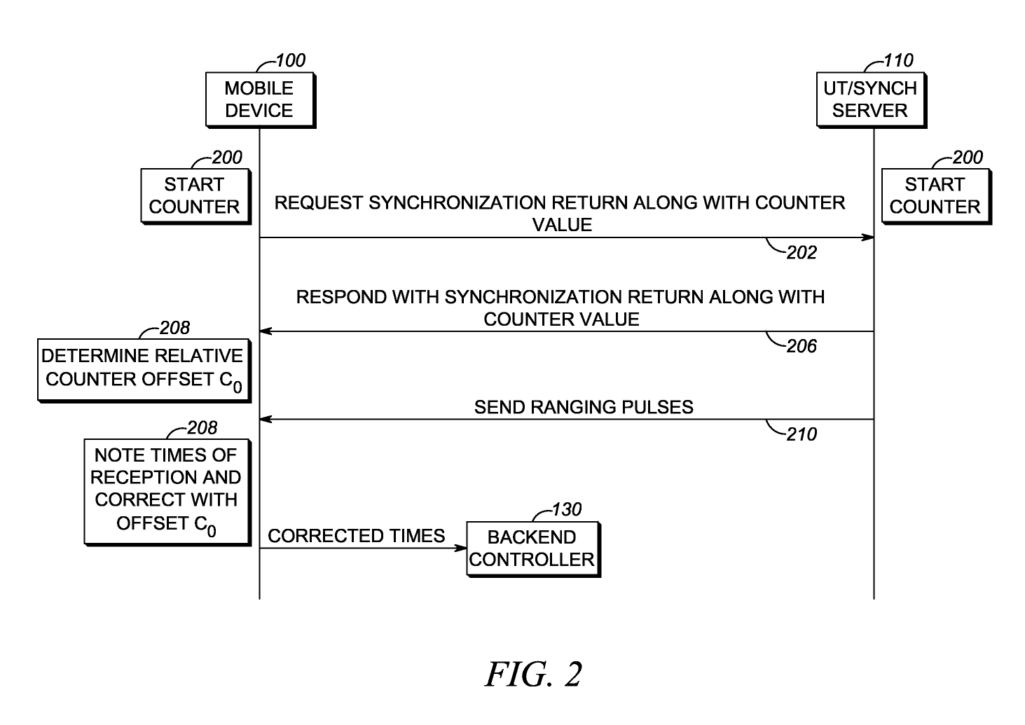

Referring to FIG. 2, when two devices (e.g. a mobile device and an ultrasonic transmitter/timing server) are first powered-up or rebooted, these devices 100, 110 start 200 their respective internal counter from zero. The mobile device 100 will then initiate a counter offset determination sequence with the synchronization server 110 through Wi-Fi™. This can be done by the mobile device requesting the synchronization server's counter value 202, such as through a request for a synchronization return. The synchronization server can then respond 206, such as in a synchronization return, with its counter value. The phone then determines 208 a relative counter offset, c₀, between its counter value and the counter value of the synchronization server by subtracting its counter value from the received counter value of the synchronization server.

It should be noted that the counters of the mobile device and server are not synchronized nor are the clocks of the mobile device and server as these clocks may be modified by other mechanisms, such as a network automatically resetting a device's clock to network time, thus adversely affecting performance. The ultrasonic transmitters/synchronization servers will also determine relative offsets amongst themselves in the same fashion as above. One of the servers, or even a mobile device, will be designated as the master synchronization server with the other servers being slaved to the master. The master can be chosen by the backend controller or can be chosen in an ad hoc manner. The relative counter offsets amongst the transmitters is reported to the backend controller for further use in locationing.

Once the relative counter offset, c₀, has been determined, ₜₕₑ ultrasonic transmitter can send 210 periodic ultrasonic ranging pulses. The pulses can be 2 ms bursts of 20 kHz sent every 800 ms, for example. The relative timing of these pulses is established between the transmitters by the backend scheduler such that they do not overlap for a mobile device within hearing distance of the transmitters. In particular, the backend scheduler knows the positions of the transmitters and can schedule the pulses so they do not overlap for a mobile device within their range. Upon receiving each pulse, the mobile device will note the measured time t of reception of the pulse based on the counter value when the pulse is detected. This time is then corrected by the relative counter offset, (t+_{c0}). The mobile device will then send this time information over the Wi-Fi™ network to the backend controller along with phone identification information. The backend controller, given the scheduled time that the pulse was emitted, and subtracting this scheduled emission time from the measured time of reception of the pulse corrected by the relative counter offset, will have the accurate flight time of the pulse in order to accurately locate the identified mobile device. The relative timing offset could be added or subtracted as needed to advance or retard the timing measurement.

The backend controller can use the flight time information from ranging pulses from different transmitters to determine the location of the mobile device accurately. It should be noted that the radio frequency communications are relatively instantaneous next to the flight time of the ultrasonic signal and therefore the communication time over Wi-Fi™ can be ignored. Using a locationing technique such as triangulation, trilateration, multilateration, and the like, along with the flight times, the backend controller can determine the location of the mobile device accurately and also track its position during subsequent bursts from the transmitters.

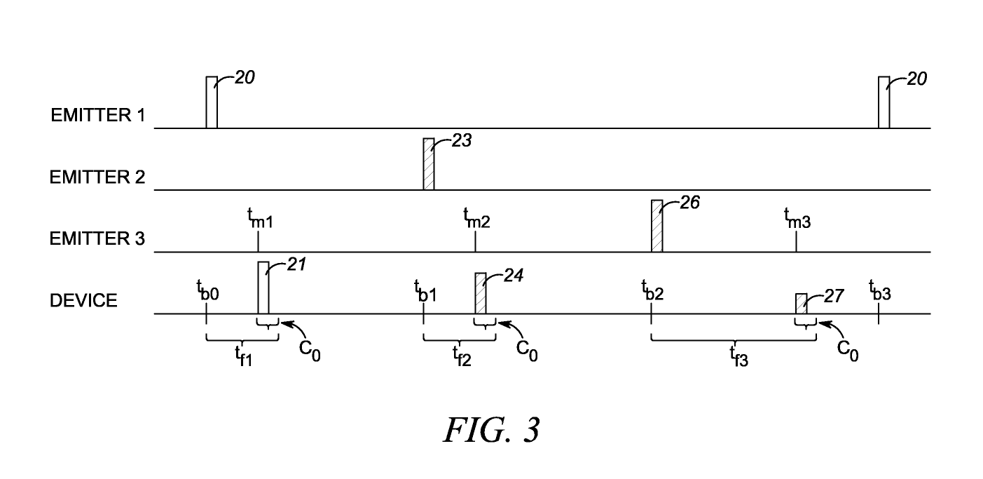

In the above scenario, the backend controller must wait for the longest possible flight time to be received by the mobile device before having other emitters (e.g. 2 and 3) trigger their ranging pulses. If not, ultrasonic signal collisions could occur, and emitter signals would not be received properly, i.e. they would be missed by the mobile device. Therefore, it is preferred to establish a maximum flight time for an environment, i.e. at a farthest distance apart for the mobile device and an emitter where the mobile device is still able to hear the emitter reliably. In other words, it is unlikely that ultrasonic signals could be detected at long distances, such as those of a large hall. Therefore, a reasonable maximum flight time can be established, such as 200 ms, which is approximately 200 feet for ultrasonic signals. This maximum flight time can be estimated or empirically determined in the actual environment. Therefore, to ensure that ultrasonic ranging pulses are not missed, a worst case flight time is determined within an environment to define a maximum buffer time period, t_{b}, and to subsequently delay any emitter from emitting by at least this maximum buffer time period. This solution is shown in FIG. 3.

In this example, a mobile device (such as device 100 of FIG. 1) is located within an environment. The mobile device is operable to receive ultrasonic ranging pulses (e.g. 20, 23, 26) from a plurality of emitters (such as emitters 116 of FIG. 1) at different times. Although only three emitters are represented, it should be realized that many more emitters could be deployed within the environment. It is envisioned that up to ten emitters can be used in a typical retail environment, for example. The backend scheduler controls the transmitters to send their periodic ranging pulses at the maximum buffer time t_{b} between each emitter pulse, which is the maximum flight time for any emitter within the environment. For example, the buffer time t_{b} can be 800 ms. At the beginning of each buffer time (i.e. t_{b0}, t_{b1}, t_{b2}) each emitter is scheduled to transmit its respective ultrasonic ranging pulse (i.e. 20, 23, 26). The time until the reception (i.e. 21, 24, 27) of each pulse defines a measured time of each signal (i.e. tₘ₁, tₘ₂, tₘ₃), which is subsequently corrected by the mobile device by adding the relative timing offset, c₀, to obtain the corrected time (i.e. tₘ₁+c₀=t_{f1}, tₘ₂+c₀=t_{f2}, tₘ₃+c₀=t_{f3}).

In the example shown, the flight times t_{f1} and t_{f2} are about the same. Therefore, it is known that the transmitters 1 and 2 are about equidistant from the receiver. The flight time t_{f3} is much longer than the flight times t_{f1} and t_{f2}, and therefore the mobile device is much farther away from transmitter 3. The flight times can be used to estimate the actual distance from the receiver given the known (measured) speed of ultrasonic sound within the environment. For example, the backend controller knows the time when each emitter transmits the ultrasonic ranging pulse since the backend scheduler scheduled that ranging pulse. The mobile device can measure the time when it receives the ranging pulse, add the relative timing offset to correct this time, wherein the emission item can be subtracted from the reception time to determine the flight time. This corrected time information is reported to the backend controller along with the mobile device identifier. If the controller finds that a determined a flight time shows that a ranging pulse is received by a mobile device between times t_{b0} and t_{b1}, for example, this tells the backend controller that the ranging pulse came from emitter 1. Using the corrected time of arrivals of the ultrasonic ranging pulses, identifying the transmitter, and using the known positions of identified transmitter, the backend controller can calculate an accurate distance to the mobile device. Given flight time information from multiple transmitters, the backend controller can use known locationing techniques to then determine an accurate position of the mobile device, which can be tracked by the backend controller during subsequent measurements.

Another aspect to consider is a change in the system over time. Since absolute clock synchronization is not being used, since devices are using their own internal clocks and Wi-Fi™ systems exhibit variable network latencies, it may be that a relative counter offset will drift over time. Drift causes significant error during extended periods when accurate synchronization packets are not available. Accordingly, the mobile device can obtain multiple repeated relative counter offset measurements that are individually weighted and then averaged.

As described above the present invention can provide accurate initial performance. During the quick initial offset determination, the initial relative counter offsets are heavily weighted based on their value, where low values are more accurate and therefore more heavily weighted. Even so, during the initial few seconds, the present invention must use any relative counter offset results obtained even if they have long round trip times.

Afterwards, to account for drift, the present invention also envisions increased accuracy over time using different techniques, such as averaging relative counter offsets within an averaging window over time and changing the size of the averaging window used based on conditions. Firstly, an average weighting of relative counter offsets is decreased over time. In this way, drift does not become pronounce or produce more outlier measurements. Secondly, the mobile device can discard previous relative counter offsets an average weighting of relative counter offsets is adapted based on number of relative counter offsets discarded in recent history. For example, if few relative counter offsets are discarded for long periods these become more important, even if they provide poor results, these relative counter offsets must be used until replaced by better relative counter offsets. In particular, the threshold for discarding relative counter offsets is adapted based on the number of relative counter offsets discarded in recent history. Thirdly, extreme long term drift calculations are used to span periods when very few low latency relative counter offsets are available. Specifically, low latency relative counter offsets are obtained in time very close together, and increasing latency is more prone to error. Therefore, the present invention can adapt the average weighting. For example, low latency relative counter offsetscan count more in an averaging calculation than higher latency relative counter offsets in order to keep up with drift.

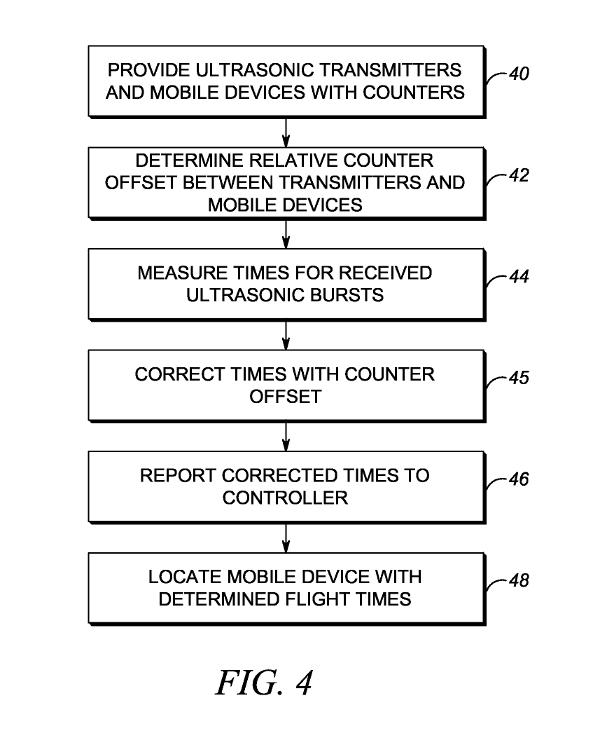

FIG. 4 is a diagram illustrating a method for using counter offsets and counter values when ultrasonic bursts are received to calculate flight times in an ultrasonic locationing system, according to some embodiments of the present invention.

A first step 40 includes providing; a plurality of transmitters each having a counter and synchronization server and being operable to emit ultrasonic bursts; a backend controller communicatively coupled to the transmitters and being operable to schedule periodic bursts from each transmitter; and a mobile device communicatively coupled to the backend controller, the mobile device having a counter and being operable to receive the ultrasonic bursts. The counters start counting from zero upon a reboot of a device or transmitter.

A next step 42 includes determining a relative counter offset between a mobile device and a transmitter that has emitted an ultrasonic burst. Optionally, this step includes taking multiple subsequent relative counter offsets obtained by the mobile device, which are then individually weighted and then averaged.

A next step 44 includes measuring a reception time for each ultrasonic burst received by the mobile device.

A next step 45 includes correcting the reception time with the relative counter offset between the mobile device and the transmitter that emitted the ultrasonic burst.

A next step 46 includes reporting the corrected time to the backend controller, which determines flight time by subtracting the known emission time of the burst by the transmitter from the reported corrected time from the mobile device.

A next step 48 includes locationing of the mobile device by the backend controller using at least two determined flight times for different respective transmitters.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system for using counter offsets and counter values when ultrasonic bursts are received to calculate flight times in an ultrasonic locationing system, the system operable on a wireless communication network, the system comprising:
a plurality of transmitters each having a counter and synchronization server and being operable to emit ultrasonic bursts;
a backend controller communicatively coupled to the transmitters and being operable to schedule periodic bursts from each transmitter; and
a mobile device communicatively coupled to the backend controller, the mobile device having a counter and being operable to receive the ultrasonic bursts, wherein the mobile device is further operable to determine a relative counter offset between itself and a transmitter;
whereupon the mobile device is further operable to measure a reception time of bursts from the transmitters, correct the reception time with the relative counter offset between the mobile device and the transmitter that emitted the ultrasonic burst, and report the corrected time to the backend controller for locationing of the mobile device.

2. The system of claim 1, wherein the counters and clocks of the mobile device and the transmitter are not synchronized.

3. The system of claim 1, wherein the relative counter offset between the mobile device and the transmitter is periodically determined by taking the difference between counter values of the mobile device and the transmitter counters, and wherein multiple subsequent relative counter offsets are determined by the mobile device and are individually weighted and then averaged.

4. The system of claim 3, wherein more recently determined relative counter offsets are more heavily weighted than older relative counter offsets.

5. The system of claim 3, wherein previous relative counter offsets are averaged over a variable-sized averaging window, and wherein an average weighting of relative counter offsets is decreased over time.

6. The system of claim 3, wherein low latency relative counter offsets are more heavily weighted than higher latency relative counter offsets.

7. The system of claim 1, wherein the counters start counting from zero upon a reboot of a device or transmitter.

8. The system of claim 1, wherein the locationing of the mobile device is performed by the backend controller using at least two flight times for different respective transmitters.

9. The system of claim 1, wherein the transmitters are further operable to determine relative counter offsets between themselves and report these relative counter offsets to the backend controller.

10. A method for using counter offsets and counter values when ultrasonic bursts are received to calculate flight times in an ultrasonic locationing system, the method comprising the steps of:
providing; a plurality of transmitters each having a counter and synchronization server and being operable to emit ultrasonic bursts; a backend controller communicatively coupled to the transmitters and being operable to schedule periodic bursts from each transmitter; and a mobile device communicatively coupled to the backend controller, the mobile device having a counter and being operable to receive the ultrasonic bursts;
determining a relative counter offset between a mobile device and a transmitter that has emitted an ultrasonic burst;
measuring a reception time for each ultrasonic burst received by the mobile device;
correcting the reception time with the relative counter offset between the mobile device and the transmitter that emitted the ultrasonic burst;
reporting the corrected reception time to the backend controller; and
locationing of the mobile device by the backend controller using determined flight times from at least two corrected times reported by the mobile device for different respective transmitters.
